(19) United States
(12) Patent Application Publication
(10) Pub. No.: US 2014/0150418 A1
(43) Pub. Date: Jun. 5, 2014

(54) Regenerating Generator

(71) Applicants: Branko Bem, Plano, TX (US); Melita Bem, Plano, TX (US)

(72) Inventors: Branko Bem, Plano, TX (US); Melita Bem, Plano, TX (US)

(21) Appl. No.: 13/861,413

(22) Filed: Apr. 12, 2013

Related U.S. Application Data
(60) Provisional application No. 61/624,267, filed on May 4, 2012.

(51) Int. Cl. F15B 1/02; F15B 1/027

(52) U.S. Cl. CPC F15B 1/024; F15B 1/027
USPC 60/415

(57) ABSTRACT

A system for generating and storing energy. The system includes an air motor/compressor for compressing air as liquid compressed air and an electric motor/multi-stage modular generator for driving the air motor/compressor. In addition, the system includes a storage facility for storing the air compressed by the electric motor/multi-stage modular generator as liquid compressed air. The air motor/compressor uses liquid compressed air from the storage facility to drive the multi-stage generator for producing electricity.

### RELATED APPLICATIONS

This utility application claims the benefit of U.S. Provisional Patent Application Ser. No. 61/624,267 filed Apr. 14, 2013 by Branko Bem and Melita Bem, which is hereby incorporated by reference.

### BACKGROUND OF THE INVENTION

1. Field of the Invention

This invention relates to energy generation devices. Specifically, and not by way of limitation, the present invention relates to a system and method of generating energy using a regenerating generator using stored liquid air.

2. Description of the Related Art

The generation and storage of energy is very important in today's world. At times, conventional energy sources, such as electricity provided by local electric companies is unavailable for a variety of reasons, such as natural catastrophes, weather related disruptions, etc. Gas-run generators provide a secondary source of energy but require the user to obtain gas to run the generator. Oftentimes, the availability of gas is also not readily available.

Thus, a system and method are needed which provides a regenerating energy system which is available for use at anytime. It is an object of the present invention to provide such a system and method.

### SUMMARY OF THE INVENTION

In one aspect, the present invention is a system for generating and storing energy. The system includes an air motor/compressor for compressing air as liquid compressed air and an electric motor/multi-stage modular generator for driving the air motor/compressor. In addition, the system includes a storage facility for storing the air compressed by the electric motor/multi-stage modular generator as liquid compressed air. The air motor/compressor uses liquid compressed air from the storage facility to drive the multi-stage generator for producing electricity.

In another aspect, the present invention is a method of generating and storing energy. The method begins by driving an air motor/compressor by an electric motor/multi-stage modular generator. Next, the air motor/compressor compresses air and stores the compressed air from the air motor/compressor as liquid air. The stored liquid air is then used as desired by the air motor/compressor to drive the electric motor/multi-stage modular generator for producing electricity.

### BRIEF DESCRIPTION OF THE DRAWINGS

FIG. 1 is a simplified block diagram of an energy generation system in one embodiment of the present invention;

FIG. 2 is a front perspective view of a portion of the energy generation system of FIG. 1;

FIG. 3 is a front perspective view of the electric motor/multi-stage modular generator of FIG. 2;

FIG. 4 is an interior view of the electric motor/multi-stage modular generator;

FIG. 5 is a front perspective view of the windmill assembly;

FIG. 6 is a front perspective view of the solar panel assembly;

FIG. 7 is a front perspective view of a Stirling collector assembly in another embodiment of the present invention; and

FIG. 8 is a flowchart illustrating the steps of using the energy generation system according to the teachings of the present invention.

### DESCRIPTION OF THE INVENTION

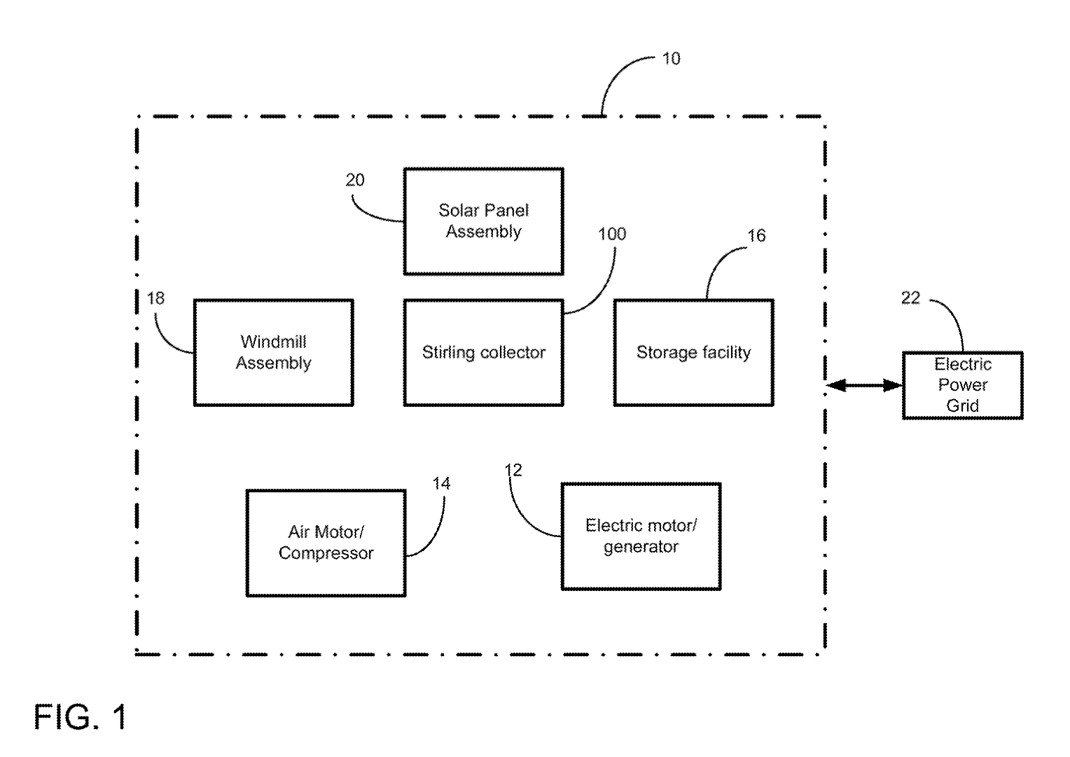

The present invention is a system for generating and storing energy in the form of liquid air. FIG. 1 is a simplified block diagram of an energy generation system 10 in one embodiment of the present invention. The system includes an electric motor/multi-stage modular generator (electric motor/generator) 12, an air motor/low pressure compressor (air motor/compressor) 14, an energy storage facility (having high pressure tanks/accumulators) 16, a windmill assembly 18, a Stirling collector assembly 100, and a solar panel assembly 20. The system may be connected to a conventional electric power grid 22 typically supplying electrical power to a plurality of homes and buildings. The energy storage facility preferably includes one or more high pressure tanks which are accumulators for storing energy.

The core of the present invention is the electric motor/generator 12 and the air motor/compressor 14 that stores and uses energy in the form of liquid air. The present invention may be used as a backup generator. However, the present invention may be used in other applications, such as a primary source of power. The electric motor/generator 12 does not produce pollution on its own and it can operate as a standalone system without connection to the power grid 22.

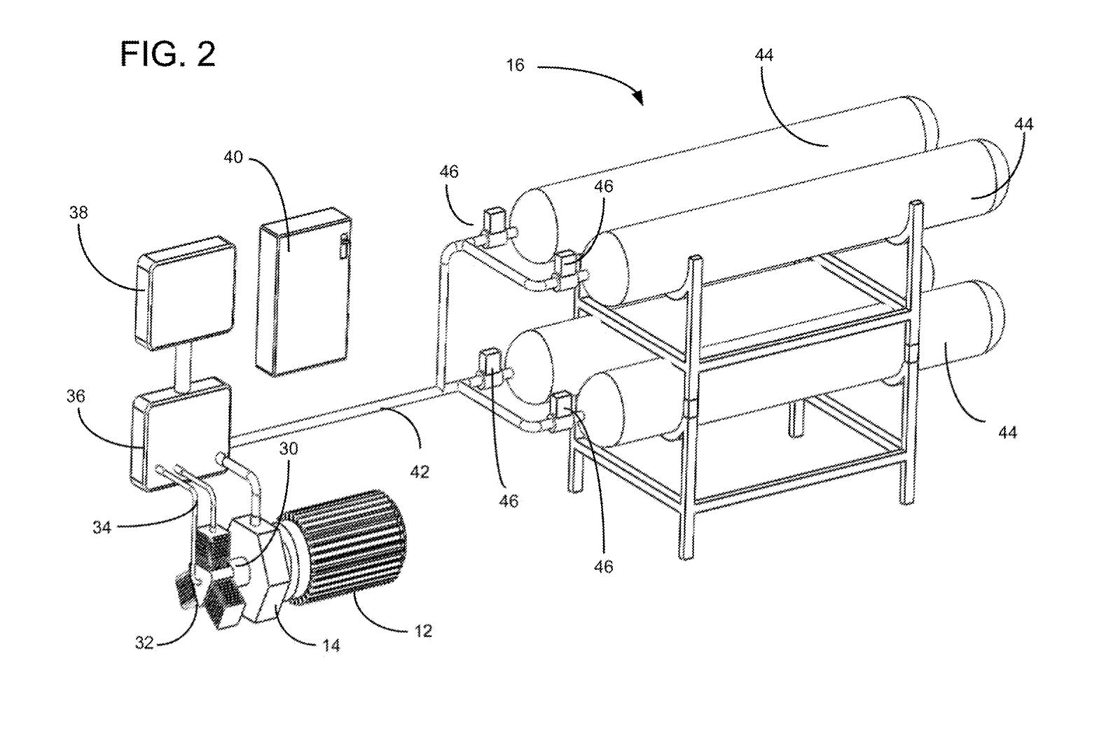

FIG. 2 is a front perspective view of a portion of the system 10 of FIG. 1. FIG. 2 illustrates the electric motor/generator 12 coupled to the air motor/compressor 14. A clutch 30 is located adjacent the air motor/compressor 14 and a high pressure compressor 32. The generated air is pumped via pipes 34 into an air flow controller condenser/heat exchanger 36. An electrical controller computer 38 is affixed to the air flow controller condenser/heat exchanger 36. FIG. 2 also illustrates a transfer switch 40. An additional pipe 42 pumps the air into the storage facility 16 having a plurality of liquid air tanks 44. The flow to the storage facility may be controlled by control valves 46. The compressed air results in liquefied air which forms in the tanks 44.

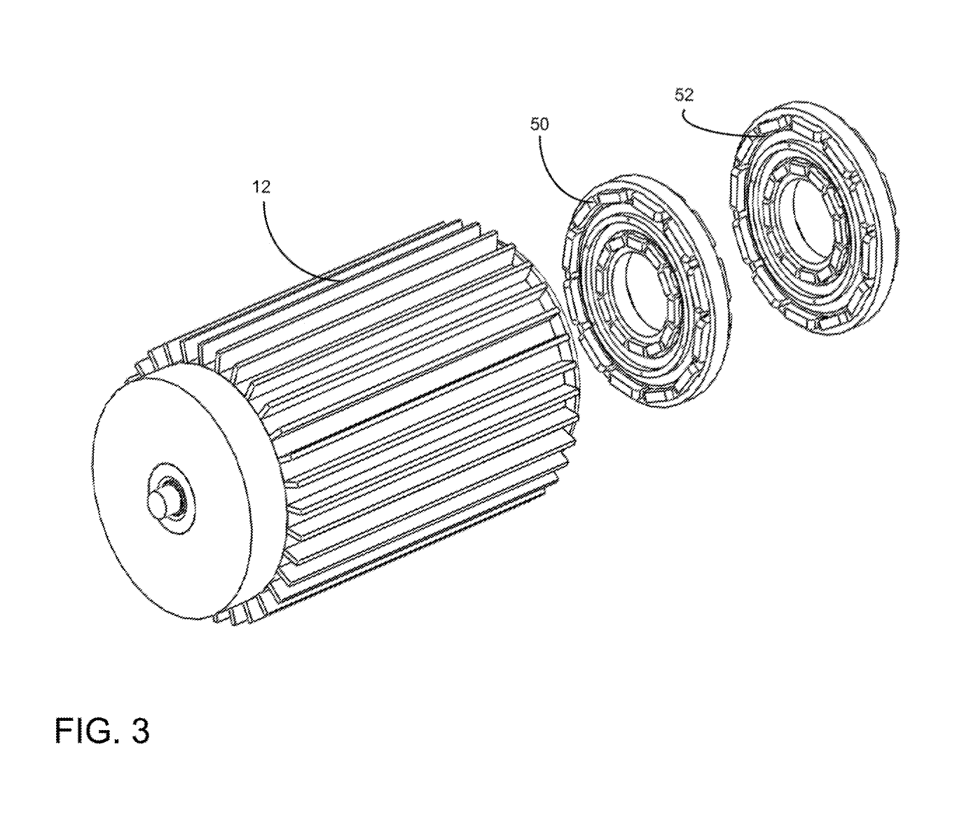

FIG. 3 is a front perspective view of the electric motor/generator 12 of FIG. 2. The electric motor/generator may have a plurality of stages 50 and 52. Although two stages are depicted, the electric motor/generator may have any number of additional stages.

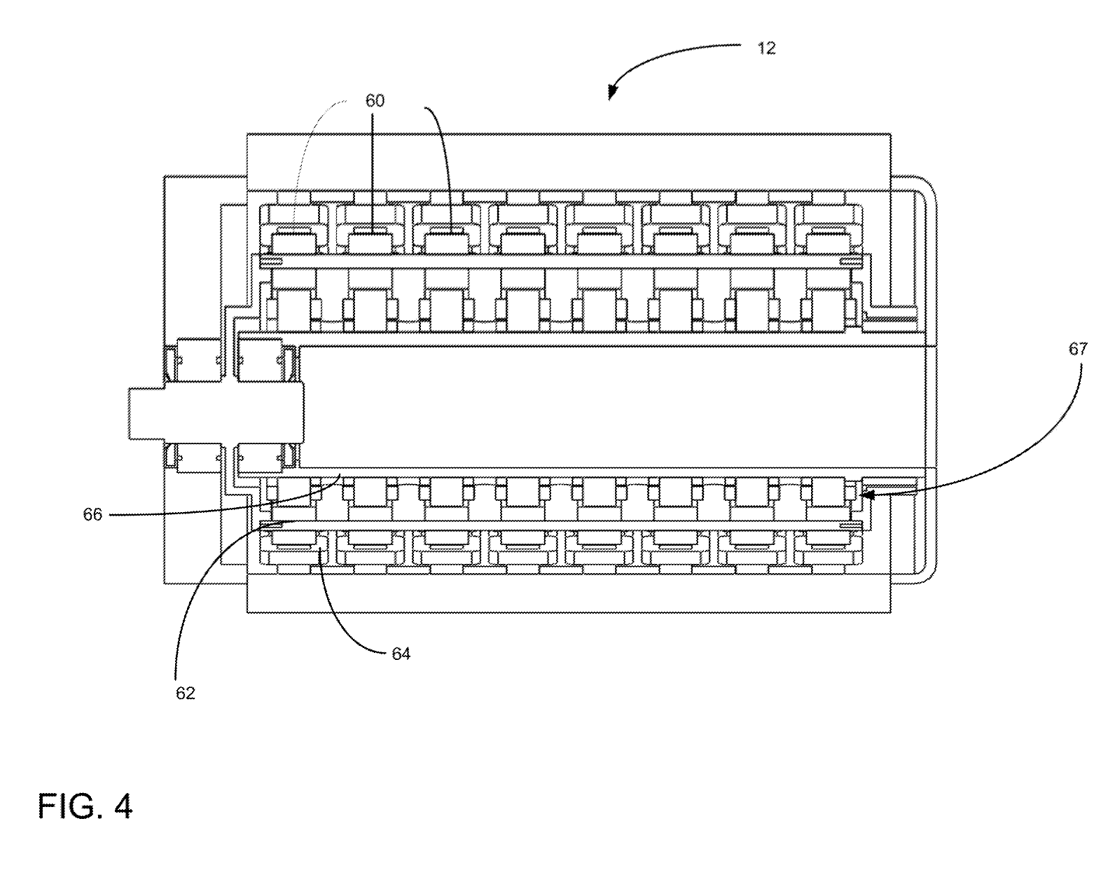

FIG. 4 is an interior view of the electric motor/generator 12. The electric motor/generator 12 may be configures as a multi-stage modular generator 60 having a rotor 62, an outer stator 64, an inner rotor 66, and an inner stator 67.

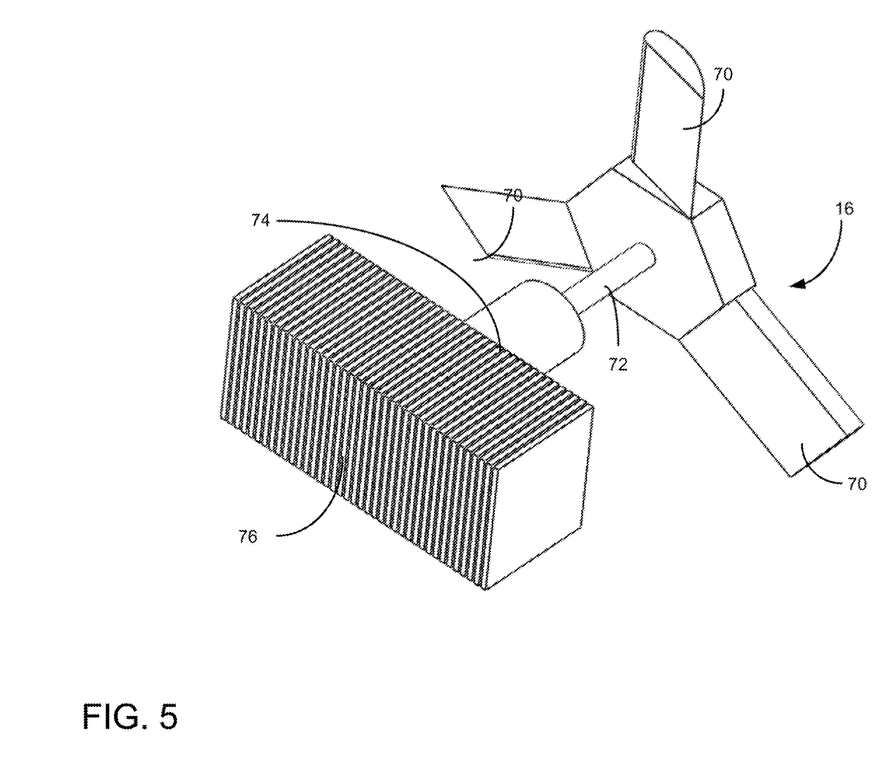

FIG. 5 is a front perspective view of the windmill assembly 18. The windmill assembly may be in a vertical or horizontal orientation and may include a plurality of propellers 70 and a shaft 72 coupled to a reduction drive 74 and a high pressure compressor 76.

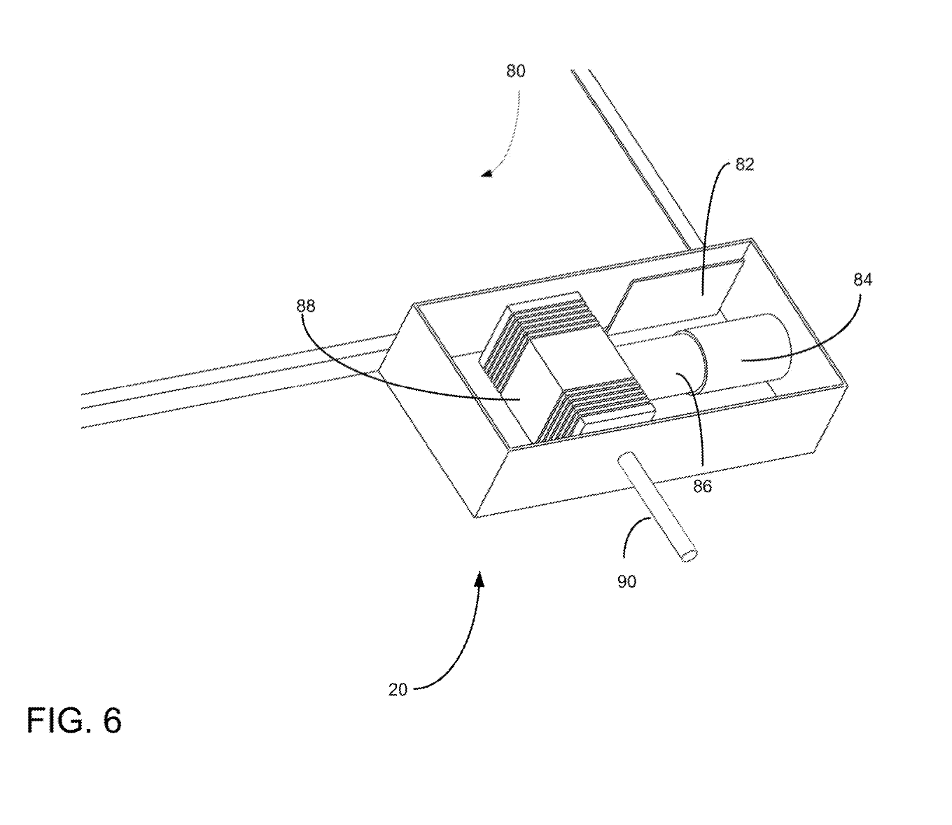

FIG. 6 is a front perspective view of the solar panel assembly 20. The solar panel assembly may include one or more solar panels 80, a controller 82, a motor 84 coupled to a reduction drive 86, and one or more high pressure compressors 88. The solar panel assembly 20 may pump air out an air output pipe 90.

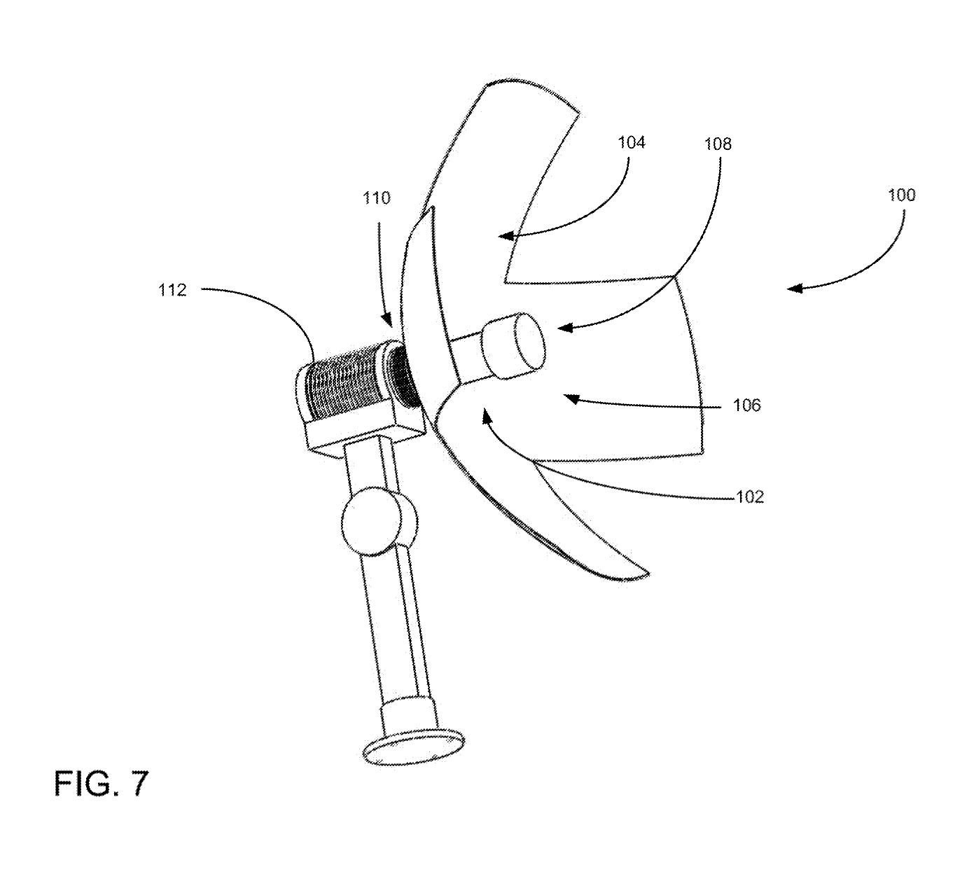

In another embodiment, the present invention may capture solar heat to drive a Stirling engine directly coupled to a compressor for providing an additional free energy source. FIG. 7 is a front perspective view of a Stirling collector assembly 100 in another embodiment of the present invention. A piston rod (not shown) of a Stirling engine 102 may be directly connected to a compressor piston (not shown), using only a linear motion. The Stirling collector assembly 100 contains a parabolic mirror 104 wherein a hot end 106 of the Stirling engine 102 is in a focal point 108 of the parabolic mirror 104 and a cold end 110 and compressor 112 are behind the mirror 104. The Stirling collector assembly is preferably on a motorized platform having pan and tilt motion. A microprocessor from a generator controller may send commands to the motorized platform for sun tracking (not shown), In this configuration, the collector is always pointed to the sun and the hot end of the Stirling engine is the focus of the mirror.

With reference to FIGS. 1-7, the operation of the system 10 will now be explained. During the standby mode, the electric motor/generator 12 operates as a motor using power from the power grid 22 to drive the air motor/compressor 14 as the first stage that is linked to the high pressure compressor 32 which acts as the second stage. The air from the atmosphere is preferably compressed to approximately 3000 PSI and stored in high pressure tanks/accumulators (high pressure tanks and/or accumulators), or until when the compressed air is liquefied, or when the compressed air is changed from a gas state to a liquid state. The liquid air is then stored in the high pressure tanks/accumulators 44. The high pressure tanks/accumulators 44 act as the accumulators/energy storage devices. In addition to the motor and the compressor running from the electric power grid, the small high pressure compressor 76, attached to the windmill assembly 18, collects free energy from the wind and stores it in the form of liquid air in the same high pressure tanks/accumulators 44. The solar panels 80 may be added as the additional free energy collector to drive a small electric motor coupled to the small electric high pressure compressor 88 which stores the energy in the form of the liquid air in the same high pressure tanks/accumulators 44. This system can be easily upgraded or scaled up or down. Furthermore, the Stirling collector assembly 100 may be added to provide an additional free energy collector to drive a high pressure compressor which also stores the energy in the form of the liquid air in the same high pressure tanks/accumulators 44.

During power outages, operation is reversed whereby stored high pressure air is used as the energy source to run the air motor/compressor 14 that is attached to the electric motor/generator 12 used to produce electric energy. To improve efficiency, heaters may be added to speed up evaporation. For example, to increase generators capacity and its runtime, adding additional high pressure tanks/accumulators 44 may be utilized to increased runtime demand. Likewise, increasing air flow and adding another generator or air motor stage will increase output to accommodate higher current demand. Solar collectors may be added to heat up the evaporator in combination with other types of heating. The heat generated from the generator operation may be used to help evaporation while liquid air helps cooling the generator.

The electrical controller computer may be utilized to provide automatic operation of the system 10 by controlling the transfer switch 40, the control valves 46 for tank selection, air flow, electric current direction control, Pressure regulators, the windmill assembly 18 operation, the solar panel assembly 20 operation, the evaporation control of the air flow controller condenser/heat exchanger 36, etc. By measuring current demand, the electrical controller computer controls the air flow to the air motor/compressor 14 to prevent unnecessary energy waste, Energy management receiving data from the weather channel may make a decision to pump the electric energy back to the grid or use the system 10 as a source of energy based on free energy availability from the wind, the sun, and the Stirling collector assembly.

The electric motor/generator 12 is preferably a multi-core generator/motor which produces high current in a small form factor and may work as a brushless servo-motor during standby operation.

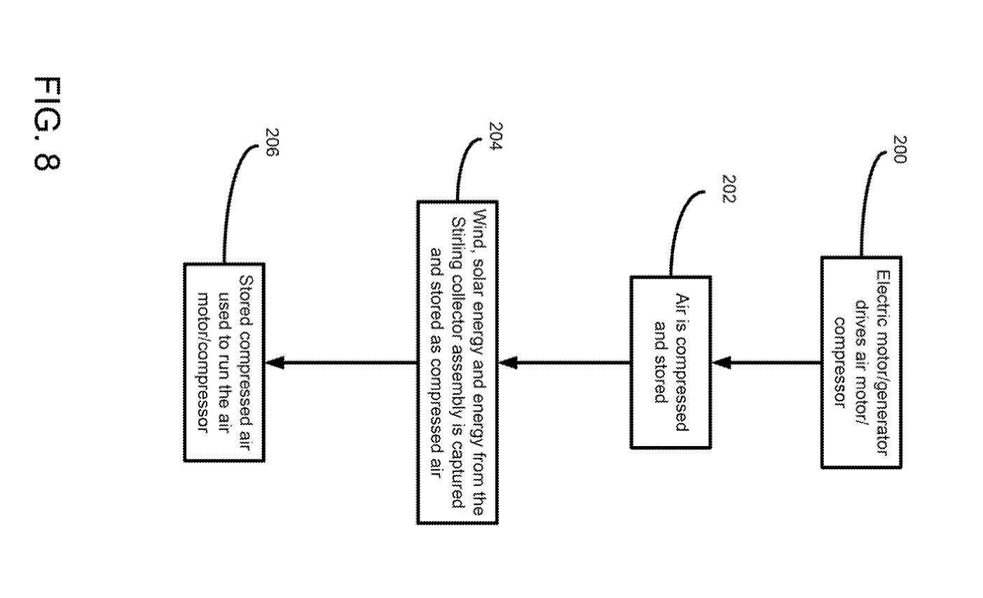

FIG. 8 is a flowchart illustrating the steps of using the energy generation system 10 according to the teachings of the present invention. With reference to FIGS. 1-8, the method will now be explained. The method begins with step 200 where the electric motor/generator 12 operates as a motor using power from the power grid 22 to drive the air motor/compressor 14 as the first stage that is linked to the high pressure compressor 32 which acts as the second stage. Next, in step 202, the air from the atmosphere is preferably compressed to 3000 PSI and stored in the high pressure tanks/accumulators 44. The high pressure tanks/accumulators 44 act as the accumulators/energy storage devices. In step 204, free energy from the wind, solar panels and the Stirling collector assembly is optionally captured and stored in the form of liquid air in the same high pressure tanks/accumulators 44. In additional, the solar panels 80 are optionally added as the additional free energy collector to drive the small electric high pressure compressor 88 which stores the energy in the form of the liquid air in the same high pressure tanks/accumulators 44. This system can be easily upgraded or scaled up or down. During power outages or as necessary, the operation of the system is reversed. In step 206, stored high pressure air is used as the energy source to run the air motor/compressor 14 that is attached to the electric motor/generator 12 for use in producing electric energy. To improve efficiency, heaters may be added to speed up evaporation. For example, to increase generator-s capacity and its runtime, adding additional high pressure tanks/accumulators 44, generators and/or air motors may be utilized to increased runtime demand. Likewise, increasing air flow and adding another generator stage will increase output to accommodate higher current demand. Solar collectors may be added to heat up the air flow controller condenser/heat exchanger in combination with other types of heating. The heat generated from the generator operation may be used to help evaporation while liquid air helps cooling the generator.

On a larger scale, the present invention may be used to store energy during surplus time periods of the electric energy and release electric energy to the power grid during high demand. This technique is used today in some power plants where water is pumped back to accumulation reservoir during surplus situations of the electric energy. In one embodiment, the system may be used in large windmill farms to store energy during surplus wind energy and lower electric demand situations and to release electric energy when needed. In another embodiment, the system may be used in large solar farms and store energy to be released at night time.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of he present invention.

1. A system for generating and storing energy, the system comprising:
an air motor/compressor for compressing air into liquid air;
an electric motor/multi-stage modular generator for driving the air motor/compressor; and
a storage facility for storing the liquid air compressed by the air motor/compressor;
wherein the air motor/compressor uses liquid compressed air from the storage facility to drive the electric motor/multi-stage modular generator to produce electricity.

2. The system for generating and storing energy according to claim 1 wherein the air motor/compressor compresses the air in a first stage and further comprising a compressor for further compressing the air in a second stage.

3. The system for generating and storing energy according to claim 1 wherein the electric motor/multi-stage module generator has a plurality of stages.

4. The system for generating and storing energy according to claim 1 wherein the compressed air from the air motor/compressor is pumped to an airflow condenser prior to storing the compressed air in the storage facility.

5. The system for generating and storing energy according to claim 1 wherein the storage facility includes at least one high pressure air tank, wherein the high pressure air tank is an accumulator for storing energy.

6. The system for generating and storing energy according to claim 1 wherein the compressed air is compressed until the air is liquefied.

7. The system for generating and storing energy according to claim 1 further comprising a windmill assembly for capturing wind energy and converting the captured wind energy as compressed air for storage in the storage facility.

8. The system for generating and storing energy according to claim 1 further comprising a solar panel assembly for capturing solar energy and converting the captured solar energy as compressed air for storage in the storage facility.

9. The system for generating and storing energy according to claim 1 further comprising a Stirling collector assembly for capturing energy using a Stirling engine and converting the captured energy as compressed air for storage in the storage facility.

10. The system for generating and storing energy according to claim 1 wherein the electric motor/multi-stage modular generator is connected to a conventional power grip providing power to the electric motor/multi-stage modular generator.

11. The system for generating and storing energy according to claim 1 further comprising an electrical controller computer for automatically controlling operation of the system.

12. The system for generating and storing energy according to claim 1 further comprising a heating mechanism for heating the compressed air for assisting in evaporation.

13. A method of generating and storing energy, the method comprising the steps of:
driving, by an electric motor/multi-stage modular generator, an air motor/compressor;
compressing air by the air motor/compressor;
storing the compressed air from the air motor/compressor as liquid air;
using the stored liquid air by the air motor/compressor to drive the electric motor/multi-stage modular generator to produce electricity.

14. The method according to claim 13 wherein the step of compressing air includes the steps of:
compressing air in a first stage by the air motor/compressor; and
compressing air in a second stage by a second compressor.

15. The method according to claim 13 wherein the step of storing the compressed air includes storing the compressed air in a high pressure air tank as liquid air.

16. The method according to claim 15 further comprising the step of conditioning the compressed air prior to storing the air in the high pressure air tank.

17. The method according to claim 13 further comprising the step of capturing wind energy and converting the captured wind energy as compressed air.

18. The method according to claim 13 further comprising the step of capturing solar energy and converting the captured solar energy as compressed air.

19. The method according to claim 13 further comprising the step of capturing energy from a Stirling engine and converting the captured energy as compressed air.

20. An energy generating system, the system comprising:
an electric motor/multi-stage modular generator for, generating electricity; and
an air motor/compressor for driving the electric motor/multi-stage modular generator;
wherein the air motor/compressor uses compressed air to drive the electric motor/multi-stage modular generator.
